(19) United States
(12) Patent Application Publication
(10) Pub. No.: US 2026/0278214 A1
(43) Pub. Date: Sep. 17, 2026

(54) MODULAR SURROGATE MODELING OF VIBRATION-INDUCED SOUND IN HVAC SYSTEMS

(71) Applicants: Mitsubishi Electric Research Laboratories, Inc., Cambridge, MA (US); Mitsubishi Electric Corporation, Tokyo (JP)

(72) Inventors: Saviz Mowlavi, Cambridge, MA (US); Mouhacine Benosman, Boston, MA (US); Kenji Iwata, Tokyo (JP); Naoki Yaegashi, Tokyo (JP); Yuya Ezaki, Tokyo (JP)

(73) Assignees: Mitsubishi Electric Research Laboratories, Inc., Cambridge, MA (US); Mitsubishi Electric Corporation, Tokyo (JP)

(21) Appl. No.: 19/259,521

(22) Filed: Jul. 3, 2025

(30) Foreign Application Priority Data
Mar. 13, 2025 (JP) 2025-040172

(51) Int. Cl. G06F 30/27

(52) U.S. Cl. CPC G06F 30/27

(57) ABSTRACT

Systems and methods are disclosed for predicting and optimizing acoustic outputs generated by vibration in HVAC pipe assemblies through the use of modular surrogate models. In accordance with some embodiments, a method includes representing a pipe assembly as a plurality of base parts. The base parts include at least straight pipe segments and curved pipe segments. The method further includes executing a first model to determine an acoustic contribution of each straight pipe segment to the acoustic output and executing a second model to determine an acoustic contribution of each curved pipe segment to the acoustic output. The method further includes summing the acoustic contribution of each straight pipe segment of and each curved pipe segment to approximate the acoustic output generated by vibration in the pipe assembly.

### TECHNICAL FIELD

Various embodiments of the present technology relate to efficient surrogate models for predicting vibration-induced sound for HVAC applications.

### BACKGROUND

Heating, ventilation, and air conditioning (HVAC) systems are widely used for maintaining comfortable and efficient environments in residential, commercial, and industrial settings. A common issue with these systems, however, is the noise generated by vibrating pipes, which can propagate disruptive or unpleasant sound waves through the surrounding environment. These sounds, which may be caused by the vibrations induced by flowing refrigerants or other working fluids, can detract from enjoyment of a space and even cause regulatory or compliance challenges in noise-sensitive areas. The design and optimization of HVAC systems to mitigate this issue is complicated by the inherent complexity of the pipe assemblies, which often consist of interconnected straight, curved, and junctional segments.

Accurately predicting the sound generated by vibrating pipes is a challenging task. Sound propagation in air is governed by the wave equation, a partial differential equation that describes the movement of sound waves. Traditional physics-based methods, such as the finite element method (FEM) or the boundary element method (BEM), rely on discretizing the wave equation to simulate the acoustic behavior of complex pipe assemblies. These techniques can provide precise results but require immense computational resources and are therefore impractical for iterative design optimization or real-time applications. On the other hand, data-driven approaches, such as those employing machine learning models, require extensive training datasets and often fail to generalize to pipe geometries beyond the limited configurations represented in the training data. These limitations underscore the need for innovative solutions that balance computational efficiency with predictive accuracy.

It is with respect to this general technical environment that aspects of the present technology disclosed herein have been contemplated. Furthermore, although a general environment has been discussed, it should be understood that the examples described herein should not be limited to the general environment identified in the background.

### BRIEF SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Various embodiments of the present technology generally relate to the prediction and mitigation of vibration-induced noise in heating, ventilation, and air conditioning (HVAC) systems. More specifically, the technology disclosed herein includes systems and methods for modeling and predicting acoustic outputs generated by vibrating pipe assemblies using modular surrogate models for efficient and accurate noise analysis and optimization. In a first embodiment, a computer-implemented method of predicting acoustic output generated by vibration in a pipe assembly of an HVAC system comprises representing the pipe assembly as a plurality of base parts that include at least straight pipe segments and curved pipe segments. The method further includes providing each straight pipe segment of the straight pipe segments as input to a first model that predicts sound generated by straight base parts and executing the first model to determine an acoustic contribution of each straight pipe segment to the acoustic output. The method further includes providing each curved pipe segment of the curved pipe segments as input to a second model that predicts sound generated by curved base parts and executing the second model to determine an acoustic contribution of each curved pipe segment to the acoustic output. The method further includes summing the acoustic contribution of each straight pipe segment and the acoustic contribution of each curved pipe segment to approximate the acoustic output generated by the vibration in the pipe assembly.

In some embodiments, the first model and the second model include at least one of a neural network, a boundary element method solver, and a combination of a neural network and a boundary element method. The first model, in some implementations, predicts the acoustic contribution of the straight pipe segments based at least in part on a geometry of the straight pipe segments and one or more vibration characteristics of the straight pipe segments. Similarly, the second model may predict the acoustic contribution of the curved pipe segments based at least in part on a geometry of the curved pipe segments and one or more vibration characteristics of the curved pipe segments. In some examples, the method further includes optimizing a layout of the pipe assembly based at least in part on the acoustic output. The acoustic output, in some examples, is the sound pressure level at a receiver location. The method may further include training the first model using one or more datasets that represent sound generated by straight pipe segments based on their geometry and vibration characteristics and training the second model using one or more datasets that represent sound generated by curved pipe segments based on their geometry and vibration characteristics. The plurality of base parts, in some examples, further includes at least one additional pipe segment including at least one of a junction, an elbow, an expansion, a contraction, and a termination.

In another embodiment, a system for predicting total sound generated by vibration in a pipe assembly includes a decomposition module configured to divide a model of the pipe assembly into a plurality of base parts including at least straight pipe segments and curved pipe segments. The system further includes a modeling module configured to execute a first model to determine an acoustic contribution of each straight pipe segment of the straight pipe segments to the total sound and execute a second model to determine an acoustic contribution of each curved pipe segment of the curved pipe segments to the total sound. The first model predicts sound generated by straight pipe segments and the second model predicts sound generated by curved pipe segments. The system further includes a processor configured to execute the decomposition module and the modeling module to predict the total sound generated by the vibration in the pipe assembly.

In yet another embodiment, one or more non-transitory computer-readable storage media have program instructions stored thereon for predicting acoustic output generated by vibration in a pipe assembly. The program instructions, when executed by a computing system, direct the computing system to perform operations, the operations including representing the pipe assembly as a plurality of base parts. The base parts include at least straight pipe segments and curved pipe segments. The operations further include executing a first model to determine an acoustic contribution of each straight pipe segment to the acoustic output and executing a second model to determine an acoustic contribution of each curved pipe segment to the acoustic output. The operations further include summing the acoustic contribution of each straight pipe segment and the acoustic contribution of each curved pipe segment to approximate the acoustic output generated by the vibration in the pipe assembly.

### BRIEF DESCRIPTION OF THE DRAWINGS

Many aspects of the disclosure can be better understood with reference to the following drawings. The components in the drawings are not necessarily drawn to scale. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an overview of modular surrogate modeling process in accordance with some embodiments of the present technology;

FIG. 2 illustrates an example of a decomposition process in accordance with some embodiments of the present technology;

FIG. 3 illustrates an overview of a modular surrogate modeling process in accordance with some embodiments of the present technology;

FIG. 4 is a first flowchart illustrating a series of steps performed by a computing system in accordance with some embodiments of the present technology;

FIG. 5 is a second flowchart illustrating a series of steps performed by a computing device in accordance with some embodiments of the present technology;

FIG. 6 illustrates an example of a noise-reduction environment in accordance with some embodiments of the present technology; and

FIG. 7 illustrates a computing system suitable for implementing the various operational environments, architectures, processes, scenarios, and sequences discussed below and with respect to the other Figures.

### DETAILED DESCRIPTION

The present technology includes systems and methods for predicting and optimizing acoustic outputs generated by vibration in heating, ventilation, and air conditioning (HVAC) pipe assemblies through the use of modular surrogate models. The system disclosed herein addresses limitations of current physics-based and data-driven approaches, including high computational demands, limited generalizability to complex geometries, and inefficiencies in real-time noise analysis and design optimization.

The vibration of pipes caused by flowing fluids in HVAC systems generates sound waves that propagate through the surrounding environment. These vibrations, often a result of modal frequencies and mechanical forces acting on the pipe assembly, produce noise that can be disruptive in a multitude of settings, such as residential, commercial, and industrial settings. The complexity of these systems, which include interconnected straight segments, curved segments, and various junctions, further complicates efforts to predict and mitigate the resulting sounds.

Some approaches for analyzing vibration-induced noise, such as physics-based models, rely on detailed simulations of the wave equation using finite element methods (FEM) or boundary element methods (BEM). While accurate, these methods require significant computational resources, making them impractical for iterative design optimization or real-time analysis. Data-drive methods, on the other hand, leverage machine learning models trained on large datasets to approximate sound outputs based on vibration characteristics. However, these approaches are typically limited to simple pipe geometries and fail to generalize to the complex configurations found in real-world HVAC systems.

Thus, there is a clear need for a solution that combines computational efficiency with the ability to accurately predict sound across diverse and intricate pipe assemblies. To address these challenges, the present technology introduces a modular surrogate modeling approach. This approach decomposes a complex pipe assembly into its fundamental components, such as straight and curved pipe segments, and employs specialized surrogate models to predict the acoustic contributions of each component. By summing these individual contributions, the system efficiently and effectively approximates the overall acoustic output, enabling real-time or near real-time noise prediction and optimization with minimal computational overhead.

Thus, in accordance with the present disclosure, a computing system divides a representation of a pipe assembly (e.g., a model or similar virtualization) into a collection of base parts, categorized into at least straight and curved parts, based on their geometry. The vibration characteristics of the pipe assembly, such as vibration velocity corresponding to various modal frequencies, are obtained and associated with each base part. These vibration characteristics serve as input parameters for surrogate models specifically designed for each type of base part. The surrogate models can be implemented using data-driven methods (e.g., neural networks trained on representative datasets), physics-based methods (e.g., BEM or FEM solvers), or a combination thereof. These models are tailored to account for the unique acoustic behavior of each base part, including factors like geometry, vibration modes, and boundary conditions.

Once the system has been decomposed into its base parts, the surrogate models are executed for each segment to calculate its individual acoustic contribution. For straight segments, the model evaluates the propagation of mostly radially emanating sound waves. For curved segments, the model accounts for scattering effects caused by the curvature. The execution of the surrogate models includes applying the input parameters, such as geometry, vibration data, and receiver location with respect to the base part, to the corresponding model for each base part. The results are acoustic output values, typically in terms of sound pressure or related metrics, for the specified receiver locations or areas of interest. The outputs from these surrogate models are computed independently, leveraging the modularity of the system to simplify calculations.

To determine the overall acoustic output of the pipe assembly, the results from the individual surrogate models are summed. This summation is made possible by the linearity of the wave equation, which governs the propagation of sound waves in air. The linearity of the wave equation allows the system to combine the contributions of each base part without requiring additional computational adjustments for interference effects between sound waves emitted by different base parts, which are non-existent. Furthermore, scattering effects arising from the presence of a base part in the path of sound waves emitted by another base part are assumed to be negligible in most practical cases. Additional base parts, such as junctions, elbows, or expansions, can be incorporated into the system by using their own surrogate models and including their contributions in the summation. The resulting output provides a comprehensive prediction of the acoustic behavior of the pipe assembly, enabling precise analysis and further optimization if necessary.

Various technical effects may be appreciated from the implementations disclosed herein. Such technical effects include the significant reduction of computational resources and time needed for predicting acoustic outputs for complex pipe assemblies while maintaining high predictive accuracy. The technology disclosed herein eliminates the need for resource-intensive global simulations, allows for the generalization of complex and diverse pipe assemblies, and overcomes limitations of traditional data-driven methods that rely on extensive training datasets and struggle with scalability.

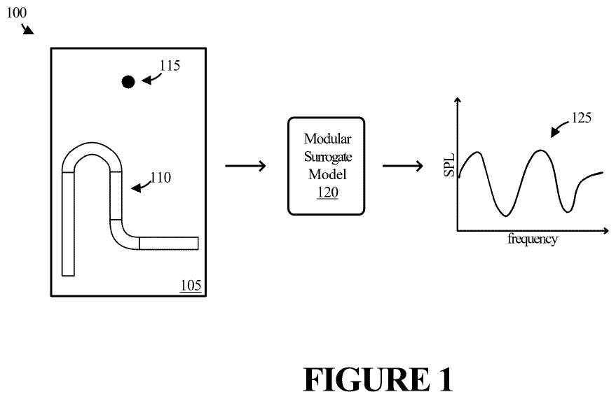

FIG. 1 illustrates surrogate modeling environment 100. Surrogate modeling environment 100 includes room 105, modular surrogate model 120, and acoustic output 125. Room 105 includes pipe assembly 110 and receiver location 115. Pipe assembly 110 is representative of a vibrating pipe assembly with a known vibrational velocity. Modular surrogate model 120 is representative of a global surrogate model as disclosed herein that may include a decomposition module, a modeling module, an optimization module, or other types of modules related to the methods disclosed herein. The elements shown in FIG. 1 are merely for purposes of example, and surrogate modeling environment 100 may include additional, fewer, or different elements than those illustrated in the example of FIG. 1.

Room 105 represents a physical environment containing pipe assembly 110 and receiver location 115. Pipe assembly 110 is representative of a full pipe assembly, prior to its decomposition into base parts for modular analysis. Thus, pipe assembly includes all relevant pipe segments, such as straight and curved components, along with any junctions, expansions, or other features. Receiver location 115 represents a specific point in room 105 where acoustic output, such as sound pressure level (SPL), is evaluated. While one receiver location is shown, multiple receiver locations may be used to gain a comprehensive understanding of the acoustic behavior of the pipe assembly and the effects throughout room 105. In some examples, localized data may produce acoustic output as a single point, such as receiver location 115, while in other examples, an array of receiver locations may be used to generate a spatial acoustic profile of the room. A spatial acoustic profile based on an array of receiver locations may help identify areas of high noise concentration and inform design decisions to mitigate undesirable acoustic effects through the environment.

Modular surrogate model 120, in some examples, includes at least a decomposition module and a modeling module that are used to predict acoustic outputs generated by pipe assembly 110. The decomposition module of modular surrogate model 120 virtually divides pipe assembly 110 into its constituent base parts, which include at least straight and curved base parts, but may include other base parts such as junctions, elbows, expansions, contractions, and terminations. The decomposition module analyzes the geometry of pipe assembly 110 to identify and categorize individual pipe segments. Geometric data such as the lengths, curvatures, and connections of pipe segments are extracted from the representation of the pipe assembly (e.g., a CAD model or other digital geometry files). The decomposition module assigns each segment to specific category (e.g., straight or curved) to prepare it for subsequent modeling in the modeling module.

The modeling module of modular surrogate model 120 determines the acoustic contributions (e.g., approximations of the acoustic contributions) of the base parts identified by the decomposition module. Each base part is paired with a surrogate model tailored to its category and/or specific properties (e.g., straight, curved, elbow). The surrogate models use input data such as vibration velocity and corresponding modal frequencies, geometric parameters, and receiver location relative to each base part, to determine acoustic output. Vibration velocity and modal frequencies may be obtained in a variety of manners, such as through physical measurements, FEA, predefined input data characterizing the dynamic behavior of the pipe assembly under operating conditions, or the like. The decomposition module, in some examples, provides the geometric data for each base part to the modeling module. The receiver location relative to each base part may be computed from receiver location 115 and the location of each base part.

The surrogate models in the modeling module may be implemented using physics-based methods, such as BEM solvers, data-driven methods, such as neural networks, or a hybrid combination of both. Physics-based models solve the wave equation governing sound propagation using numerical methods. Data-driven models approximate the relationship between inputs and acoustic outputs based on training data. When executing the surrogate models, the relevant input data for each base part is applied, and the model calculates the acoustic contribution of the segment. For physics-based models, this can involve numerical computations based on the wave equation and boundary conditions. For data-driven models, this can involve running the inputs through one or more trained neural networks to obtain the predicted output. The results from all surrogate models are aggregated to compute the total acoustic output at one or more receiver locations, producing comprehensive noise analysis and the ability to conduct system optimization.

Acoustic output 125 is illustrated as a graph of frequency versus sound pressure level (SPL). Acoustic output 125 illustrates the predicted acoustic characteristics of pipe assembly across a range of frequencies. The x-axis represents frequency, often measured in hertz (Hz), and the y-axis represents SPL, often measured in decibels (dB). Acoustic output 125 provides a frequency-domain analysis of the sound generated by pipe assembly 110, enabling identification of dominant frequencies where noise levels peak. Such peaks often correspond to modal frequencies of the pipe assembly or resonances within the system. Based on acoustic output 125, an engineer may be able to quickly visualize how the acoustic output varies with frequency and identify problem areas that may require design adjustments, such as altering pipe geometry or damping specific vibrational modes to reduce noise at key frequencies.

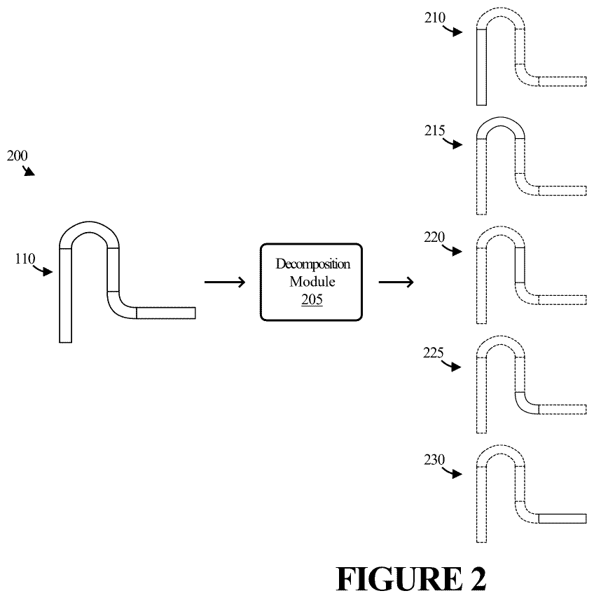

FIG. 2 illustrates decomposition environment 200. Decomposition environment 200 includes pipe assembly 110, decomposition module 205, straight pipe segment 210, curved pipe segment 215, straight pipe segment 220, curved pipe segment 225, and straight pipe segment 230. Decomposition module 205 is representative of a pipe assembly decomposition module disclosed herein that detects pipe assembly base parts and virtually divides pipe systems into base parts. The elements shown in FIG. 2 are merely for purposes of example, and decomposition environment 200 may include additional, fewer, or different elements than those illustrated in the example of FIG. 2.

Decomposition module 205 takes pipe assembly 110 as input and divides it into its constituent base parts, which include straight pipe segment 210, curved pipe segment 215, straight pipe segment 220, curved pipe segment 225, and straight pipe segment 230. Decomposition module 205 decomposes the assembly based on a provided representation of the pipe assembly, which may be provided as a CAD model, a mesh file, or other digital geometry formats containing the structural and dimensional details of the system.

Decomposition module analyzes the input geometry to identify regions corresponding to distinct structural features of the pipe assembly. Straight and curved segments may be distinguished based on geometric criteria such as local curvature, length, and the continuity of the pipe surface. For instance, a straight pipe segment may be identified as a region with negligible curvature along the pipe axis, while a curved pipe segment may be characterized by a consistent curvature radius along the pipe axis over a defined segment length. In some examples, the module scans the input representation sequentially, segmenting the geometry wherever a transition between straight and curved characteristics is detected.

Once identified, each segment may be labeled according to its type (e.g., straight or curved). In the example of FIG. 2, the pipe segments labeled straight are straight pipe segment 210, straight pipe segment 220, and straight pipe segment 230. The pipe segments labeled curved are curved pipe segment 215 and curved pipe segment 225. The geometric properties of each base part, such as segment length, curvature radius (if applicable), and cross-sectional dimensions, may be further extracted and stored in association with each identified segment. These parameters may then be made available as output for use by other modules, such as the modeling module, which may utilize some or all of this information to calculate the approximate acoustic contributions of each base part.

As previously described, the underlying physics of the decomposition approach disclosed herein is based on the wave equation, which governs the propagation of sound waves in air. The wave equation is a second-order partial differential equation (PDE) expressed as

$$\frac{{\partial }^{2} u}{\partial {t}^{2}} = {c}^{2} {∇}^{2} u .$$

In accordance with the disclosed technology, the full pipe assembly is decomposed into straight and curved pipe segments, or base parts. The sound generated by the full pipe assembly is then approximated as the sum of the sound generated individually by every base part vibrating in isolation. Assuming the pipe assembly is made up of N base parts, the sound pressure can be expressed as

$$P = {\sum }_{i = 1}^{N} {P}^{( i )} ,$$

where p⁽ⁱ⁾ denotes the sound pressure at receiver location xᵣ, the coordinates of the receiver location, induced by the ith base part vibrating in isolation. In the sum, the base parts are vibrating with the same vibration velocity as they have in the full pipe assembly. By treating the straight and curved pipe segments separately, the total sound pressure can be expressed as P=Σ_{i∈S}_{_{straight}} P⁽ⁱ⁾+Σ_{i∈S}_{_{curved}}P⁽ⁱ⁾, where S_{straight} and S_{curved} denote the indices of the straight and curved base parts, respectively. This decomposition allows the initial problem of developing a global surrogate model for a complex pipe assembly to be reduced into only two base surrogate models for straight and curved pipe segments. Denoting these surrogate models as M_{straight} and M_{curved}, respectively, the sound pressure can be expressed as P=Σ_{i∈S}_{_{straight}} M_{straight} (ω; xᵣ, X⁽ⁱ⁾, U⁽ⁱ⁾)+Σ_{i∈S}_{_{curved}} M_{curved}(ω; xᵣ, X⁽ⁱ⁾, U⁽ⁱ⁾), where X⁽ⁱ⁾ and U⁽ⁱ⁾ contain the subsets of X, the coordinates of the n nodes of a mesh representing the geometry of the pipe assembly, and U, the modal vibration velocity corresponding to frequency ω at each node, that belong to the ith base part, fully characterizing its geometry and vibration velocity.

This decomposition approach requires significantly less computational resources than a global surrogate model. Once the decomposition is obtained, data-driven or physics-based modeling approaches can be used to find M_{straight} and M_{curved}. It should be noted that this modular approach is justified by the linearity of the wave equation. The approach disclosed herein may lead to a small reduction in accuracy in the predicted SPL compared to a global surrogate model, as the interference of neighboring base parts with sound waves emitted by other base parts is ignored. However, results indicate that the reduction in accuracy is not only reasonable, but such interference effects are negligible in three-dimensional space.

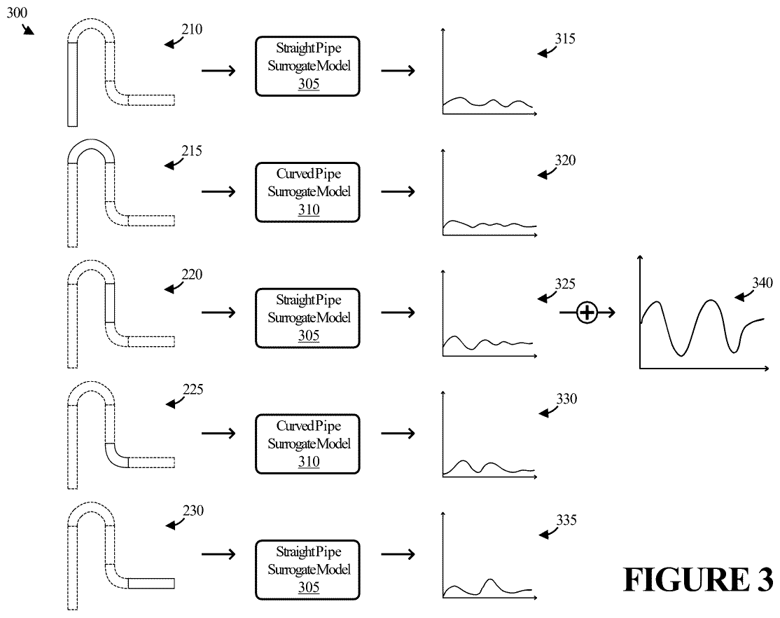

FIG. 3 illustrates the process of calculating the acoustic contributions of individual base parts within a pipe assembly using surrogate models in modeling environment 300. Modeling environment 300 includes straight pipe segment 210, curved pipe segment 215, straight pipe segment 220, curved pipe segment 225, straight pipe segment 230, straight pipe surrogate model 305, acoustic contribution 315, acoustic contribution 320, acoustic contribution 325, acoustic contribution 330, acoustic contribution 335, and acoustic output 340. Straight pipe surrogate model 305 is representative of a sound prediction model as disclosed herein that determines the acoustic output of straight pipe segments in isolation. Curved pipe surrogate model 310 is representative of a sound prediction model as disclosed herein that determines the acoustic output of curved pipe segments in isolation. The elements shown in FIG. 3 are merely for purposes of example, and modeling environment 300 may include additional, fewer, or different elements than those illustrated in the example of FIG. 3.

In the example of FIG. 3, each base part identified by decomposition module 205 from FIG. 2 is paired with a specific surrogate model based on its type—either straight or curved. These surrogate models are designed to predict the acoustic contribution of the base parts by processing their respective input parameters, such as vibration velocity, modal frequencies, geometric characteristics, and receiver location relative to the base parts.

Straight pipe segment 210, straight pipe segment 220, and straight pipe segment 230 are provided as inputs to straight pipe surrogate model 305. Straight pipe surrogate model 305 computes acoustic contribution 315 of straight pipe segment 210, acoustic contribution 325 of straight pipe segment 220, and acoustic contribution 335 of straight pipe segment 230 for a given receiver location. Curved pipe segment 215 and curved pipe segment 225 are provided as input to curved pipe surrogate model 310, which computes acoustic contribution 320 and acoustic contribution 330 at the given receiver location. Each surrogate model in the present example utilizes the geometric and vibrational properties of its respective input segment to predict the contribution of that segment to the overall acoustic output of the pipe assembly at the given receiver location.

Once the acoustic contributions for all base parts are computed, they are summed to produce the total acoustic output at the given receiver location, acoustic output 340, of overall pipe assembly, pipe assembly 110. Acoustic output 340 represents a prediction of the sound pressure level (SPL) at the receiver location.

Straight pipe surrogate model 305 is configured to predict the acoustic contribution of a straight pipe segment based on its geometry, vibration characteristics, modal frequencies, and a receiver location. The model may utilize various methodologies, including a physics-based approach, data-driven techniques, or a combination of the two. In a physics-based implementation, the model may solve the wave equation or related acoustic propagation equations using numerical methods such as the boundary element method, which relies on discretizing the straight pipe segment's geometry and applying vibration data as boundary conditions to compute the resulting acoustic output at the receiver location.

Alternatively, or in conjunction, straight pipe surrogate model 305 may use a data-driven approach such as one or more neural networks or other machine learning models. These models are trained on datasets that map input parameters—such as vibration velocity profiles, pipe length, cross-sectional dimensions, receiver location, and operating conditions—to observed or simulated acoustic outputs. A hybrid approach combines the predictive precision of physics-based models with the efficiency and adaptability of data-driven techniques.

Straight pipe surrogate model 305, in some examples, takes as input one or more geometric parameters (e.g., length, cross-sectional area), vibration characteristics (e.g., vibration velocity profiles and corresponding modal frequencies), receiver characteristics (e.g., receiver location relative to the pipe segment) and/or environmental factors (e.g., surrounding air properties). The output of straight pipe surrogate model 305 is the acoustic contribution of the provided straight pipe segment, expressed as sound pressure level or other sound-related metrics, at one or more predefined receiver locations.

Curved pipe surrogate model 310 is configured to predict the acoustic contribution of a curved pipe segment based on its geometry, vibration characteristics, modal frequencies, and a receiver location. The model may utilize various methodologies, including a physics-based approach, data-driven techniques, or a combination of the two. In a physics-based implementation, the model may solve the wave equation or related acoustic propagation equations using numerical methods such as the boundary element method, which relies on discretizing the curved pipe segment's geometry and applying vibration data as boundary conditions to compute the resulting acoustic output at the receiver location.

Alternatively, or in conjunction, curved pipe surrogate model 310 may use a data-driven approach such as one or more neural networks or other machine learning models. These models are trained on datasets that map input parameters—such as vibration velocity profiles, pipe length, cross-sectional dimensions, receiver location, and operating conditions—to observed or simulated acoustic outputs. A hybrid approach combines the predictive precision of physics-based models with the efficiency and adaptability of data-driven techniques.

Curved pipe surrogate model 310, in some examples, takes as input one or more geometric parameters (e.g., length, cross-sectional area), vibration characteristics (e.g., vibration velocity profiles and corresponding modal frequencies), receiver characteristics (e.g., receiver location relative to the pipe segment), and/or environmental factors (e.g., surrounding air properties). The output of curved pipe surrogate model 310 is the acoustic contribution of the provided curved pipe segment, expressed as sound pressure level or other sound-related metrics, at one or more predefined receiver locations.

Each predicted acoustic contribution (i.e., acoustic contribution 315, acoustic contribution 320, acoustic contribution 325, acoustic contribution 330, and acoustic contribution 335) represents the sound generated by the pipe segment under given conditions. The output may be expressed as sound pressure or SPL at one or more receiver locations, as a function of frequency in certain examples. The output may include a frequency spectrum showing how the acoustic energy is distributed across different frequencies, which can help identify resonant peaks and characterize the noise profile. In some examples, the output may also provide directional information, indicating how sound radiates from the pipe segment into the surrounding space.

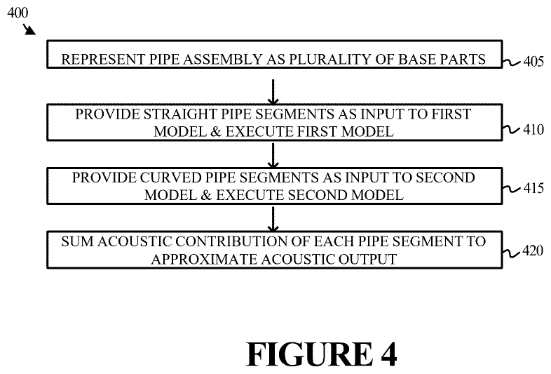

FIG. 4 illustrates process 400. Process 400 is an exemplary operation of modeling acoustic contributions from a pipe assembly in surrogate modeling environment 100 from FIG. 1, which may include decomposition environment 200 from FIG. 2 and/or modeling environment 300 from FIG. 3, in certain examples. The operations may vary in other examples. The operations of process 400, in some examples, are performed by a computing system including at least a processing system, a storage system, and software (e.g., computing system 701).

The operations of process 400 include representing a pipe assembly as a plurality of base parts (step 405). In the example of FIG. 2, decomposition module 205 takes as input pipe assembly 110, detects a plurality of straight and curved pipe segments making up pipe assembly 110 (i.e., “base parts”), and outputs a representation of the plurality of base parts (i.e., straight pipe segment 210, curved pipe segment 215, straight pipe segment 220, curved pipe segment 225, and straight pipe segment 230). The representation of the plurality of base parts may include some or all of geometric data for each base part (e.g., length, cross-sectional area, curvature, etc.), vibration characteristics for each base part (e.g., vibration velocity, modal frequencies, mode shapes, etc.), material properties for each base part (e.g., density, elasticity, etc.), receiver location relative to each base part, or the like.

The operations of process 400 further include providing the straight pipe segments as input to a first model and executing the first model for each of the straight pipe segments (step 410). In the example of FIG. 3, straight pipe segment 210, straight pipe segment 220, and straight pipe segment 230 are each provided to straight pipe surrogate model 305. Providing the respective base parts to the surrogate model, in some examples, means providing some or all of the data produced by decomposition module 205 for the base part as input to the model. For example, straight pipe surrogate model 305 may take as input one or more of geometric data, vibration characteristics, material properties, or the like. Straight pipe surrogate model 305 may further take as input one or more receiver locations, relative to the base part, for which to solve for the acoustic output (e.g., sound pressure level).

Executing the first model, as included in step 410, includes running straight pipe surrogate model 305 for each straight pipe segment for at least one receiver location. When run, straight pipe surrogate model 305 processes the one or more inputs listed above (i.e., geometric data, vibration characteristics, material properties, etc.) to predict the acoustic behavior of the pipe segment. In a physics-based implementation of straight pipe surrogate model 305, the data may be used to solve the wave equation and/or apply boundary conditions in a numerical solver like a BEM or FEM. In a data-driven implementation of straight pipe surrogate model 305, the input data is fed to a pre-trained machine learning algorithm (e.g., a neural network) that outputs a prediction of the acoustic output based on patterns learned from the training dataset(s). In a hybrid implementation of straight pipe surrogate model 305, physics-based methods may inform the machine learning model, or the two approaches may work together iteratively, in some examples.

Straight pipe surrogate model 305 outputs a predicted acoustic contribution for each input pipe segment. In the example of FIG. 3, straight pipe surrogate model 305 outputs acoustic contribution 315, acoustic contribution 325, and acoustic contribution 335. The predicted acoustic contributions represent the sound generated by each pipe segment under given conditions. The output may be expressed as sound pressure or SPL at one or more receiver locations, as a function of frequency in certain examples. The output may include a frequency spectrum showing how the acoustic energy is distributed across different frequencies, which can help identify resonant peaks and characterize the noise profile. In some examples, the output may also provide directional information, indicating how sound radiates from the pipe segment into the surrounding space.

The operations of process 400 further include providing the curved pipe segments as input to a second model and executing the second model for each of the curved pipe segments (step 415). In the example of FIG. 3, curved pipe segment 215 and curved pipe segment 225 are each provided to curved pipe surrogate model 310. Providing the respective base parts to the surrogate model, in some examples, means providing some or all of the data produced by decomposition module 205 for the base part as input to the model. For example, curved pipe surrogate model 310 may take as input one or more of geometric data, vibration characteristics, material properties, or the like. Curved pipe surrogate model 310 may further take as input one or more receiver locations, relative to the base part, for which to solve for the acoustic output (e.g., sound pressure level).

Executing the second model, as included in step 415, includes running curved pipe surrogate model 310 for each curved pipe segment for at least one receiver location. When run, curved pipe surrogate model 310 processes the one or more inputs listed above (i.e., geometric data, vibration characteristics, material properties, etc.) to predict the acoustic behavior of the pipe segment. In a physics-based implementation of curved pipe surrogate model 310, the data may be used to solve the wave equation and/or apply boundary conditions in a numerical solver like a BEM or FEM. In a data-driven implementation of curved pipe surrogate model 310, the input data is fed to a pre-trained machine learning algorithm (e.g., a neural network) that outputs a prediction of the acoustic output based on patterns learned from the training dataset(s). In a hybrid implementation of curved pipe surrogate model 310, physics-based methods may inform the machine learning model, or the two approaches may work together iteratively, in some examples.

Curved pipe surrogate model 310 outputs a predicted acoustic contribution for each input pipe segment. In the example of FIG. 3, curved pipe surrogate model 310 outputs acoustic contribution 320 and acoustic contribution 330. The predicted acoustic contributions represent the sound generated by each pipe segment under given conditions. The output may be expressed as sound pressure or SPL at one or more receiver locations, as a function of frequency in certain examples. The output may include a frequency spectrum showing how the acoustic energy is distributed across different frequencies, which can help identify resonant peaks and characterize the noise profile. In some examples, the output may also provide directional information, indicating how sound radiates from the pipe segment into the surrounding space.

The operations of process 400 further include summing the acoustic contribution of each pipe segment to approximate the acoustic output of the pipe assembly (step 420). In the example of FIG. 3, acoustic contribution 315, acoustic contribution 320, acoustic contribution 325, acoustic contribution 330, and acoustic contribution 335 are summed to produce acoustic output 340, an approximation of the total sound (e.g., sound pressure or SPL) produced by pipe assembly 110 at a given receiver location. To sum the acoustic contribution of each pipe segment to approximate the acoustic output of the pipe assembly, one or more modules mathematically combine the individual acoustic outputs (e.g., sound pressure levels or sound pressures) predicted for each segment to determine the overall acoustic behavior of the entire assembly. The summation process, in some examples, involves adding the pressure at each frequency point to generate a total sound pressure level (SPL) spectrum for the assembly. This aggregated data provides a comprehensive representation of the total acoustic output from the pipe assembly, enabling engineers to assess and optimize the overall noise performance of the system.

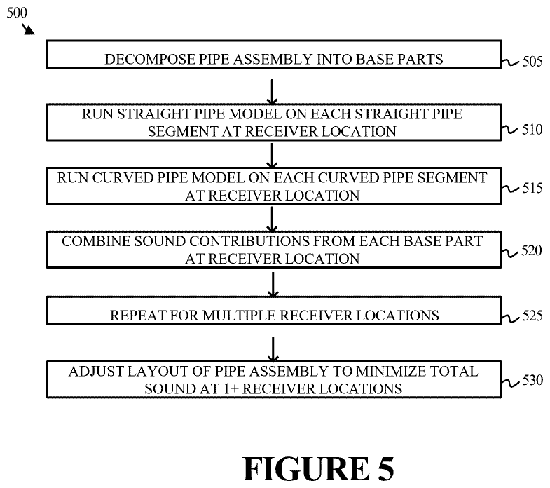

FIG. 5 illustrates process 500. Process 500 is an exemplary operation of modeling and optimizing sound from a pipe assembly in accordance with some examples of the present technology. Some or all of the steps of process 500 may be performed in surrogate modeling environment 100 from FIG. 1, which may include decomposition environment 200 from FIG. 2 and/or modeling environment 300 from FIG. 3, in certain examples. The operations may vary in other examples. The operations of process 500, in some examples, are performed by a computing system including at least a processing system, a storage system, and software (e.g., computing system 701).

The operations of process 500 include decomposing a pipe assembly into base parts (step 505). To decompose a pipe assembly into base parts, a decomposition module analyzes the geometric and/or structural representation of the pipe assembly and segments it into distinct components, which may be categorized as at least straight and curved pipe segments. The decomposition module takes as input a digital representation of the pipe assembly, such as a CAD model, mesh, or parametric design file, which contains information about the geometry, dimensions, and/or connectivity of the pipes. The decomposition module may identify transitions between straight and curved sections based on criteria such as curvature, length, and changes in direction. Each resulting segment is labeled as a base part and characterized by its geometric properties, such as length, curvature radius, and cross-sectional area, which can be used in subsequent modeling. This decomposition reduces the complexity of analyzing the entire assembly by breaking it into simpler components, each of which can be modeled individually using specialized surrogate models.

The operations of process 500 further include running a straight pipe model on each straight pipe segment at a receiver location (step 510). In accordance with step 510, a straight pipe model predicts the acoustic contribution of each straight pipe segment to the sound pressure or sound pressure level (SPL) at the designated receiver location. The input data to the model may include the geometric parameters of the segment (e.g., length, cross-sectional area), vibration characteristics (e.g., vibration velocity, modal frequencies), and/or the spatial relationship between the segment and the receiver location (e.g., distance, angle). The model processes this data to solve for the acoustic response, which is typically frequency-dependent and may include a spectrum of sound pressure values. The output represents the segment's contribution to the acoustic field at the receiver location, enabling further analysis or combination with contributions from other segments in the assembly.

The operations of process 500 further include running a curved pipe model on each curved pipe segment at a receiver location (step 515). In accordance with step 515, a curved pipe model predicts the acoustic contribution of each curved pipe segment to the sound pressure or sound pressure level (SPL) at the designated receiver location. The input data to the model may include the geometric parameters of the segment (e.g., length, cross-sectional area), vibration characteristics (e.g., vibration velocity, modal frequencies), and/or the spatial relationship between the segment and the receiver location (e.g., distance, angle). The model processes this data to solve for the acoustic response, which is typically frequency-dependent and may include a spectrum of sound pressure values. The output represents the segment's contribution to the acoustic field at the receiver location, enabling further analysis or combination with contributions from other segments in the assembly.

The operations of process 500 further include combining the sound contributions from each base part at the receiver location (step 520). To combine the sound contributions from each base part, a summing module may mathematically aggregate the individual acoustic outputs—such as sound pressures or sound pressure levels (SPLs)—predicted for each base part at the specific receiver point. The data being combined may include frequency-dependent sound pressure values for each base part, calculated by their respective surrogate models. These values are summed in a manner consistent with the linearity of the wave equation, which allows for superposition of sound waves. The result is a total acoustic response at the receiver location, providing a comprehensive representation of how the combined vibrations and geometries of all base parts contribute to the overall sound field at that point.

The operations of process 500 further include repeating step 510 through step 520 for multiple receiver locations (step 525). Repeating step 510, step 515, and step 520 for multiple receiver locations includes calculating the acoustic contributions of each base part at several different points in space and combining them. The repetition is performed to generate a comprehensive acoustic map of the system and/or room, allowing engineers or other processing modules to analyze how sound propagates and is perceived across various positions in the surrounding environment (e.g., room 105). Such an analysis may be helpful for identifying areas of high noise intensity and optimizing the pipe assembly design to mitigate undesirable acoustic effects, such as excessive noise.

The operations of process 500 further include adjusting the layout of the pipe assembly to minimize the total sound at one or more receiver locations (step 530). To adjust the layout, an optimization module may iteratively modify the geometric configuration of a pipe assembly (e.g., pipe assembly 110)—such as the positions, orientations, or lengths of the pipe segments—for evaluating the acoustic output. In other words, an optimization module may analyze the results output from the surrogate model for the multiple receiver locations, adjust the layout of the pipe assembly, and then instruct the modular surrogate model to repeat steps 505 through 525 for each new layout. One or more optimization algorithms, such as gradient descent, genetic algorithms, and/or machine learning-based methods, may be employed to identify configurations that are likely to reduce the overall acoustic output at the various receiver points. Step 530 may repeat until a layout with a desirable or optimized noise output is discovered.

The systems and methods disclosed herein may further include training the various models that may be implemented to conduct the processes disclosed herein. For example, in data-driven or hybrid implementations of the surrogate models disclosed herein, the straight pipe model and curved pipe model may be trained on one or more datasets that represent sound generated by their respective pipe segment types. In such implementations, training may involve the use of machine learning techniques to develop predictive models that map input parameters to acoustic outputs for each type of base part (e.g., straight and curved segments). Datasets may be put together consisting of input-output pairs, where the inputs represent the geometric, vibrational, and environmental properties of a base part, in addition to one or more receiver locations, and the outputs correspond to the acoustic contributions, such as sound pressure or sound pressure levels, measured or simulated at the specified receiver locations. The input data may include parameters such as segment length, curvature (for curved segments), cross-sectional dimensions, vibration velocity, modal frequencies, receiver location, and material properties, while the output data is typically derived from numerical simulations (e.g., finite element or boundary element methods) or physical experiments.

Such machine learning models, such as neural networks, may be trained iteratively on this dataset using optimization techniques like stochastic gradient descent. During each iteration, the model adjusts its internal parameters to minimize the difference between the predicted and actual acoustic outputs. This process continues until the model achieves an acceptable level of accuracy, as determined by performance metrics such as mean squared error or cross-validation accuracy. For optimization models disclosed herein, training may involve generating synthetic scenarios to refine algorithms that adjust pipe layouts to minimize total noise at specific receiver locations. The trained models may then be validated on unseen data to ensure generalizability and robustness, enabling accurate predictions for a wide range of pipe configurations and operating conditions.

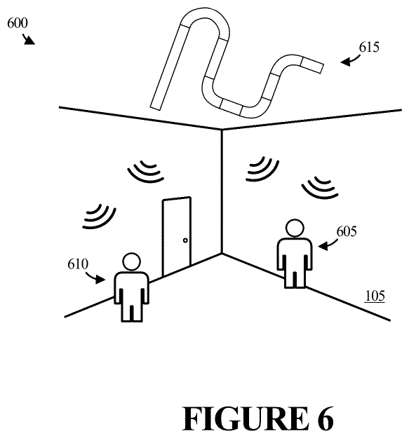

FIG. 6 illustrates noise reduction environment 600. Noise reduction environment 600 includes room 105, person 605, person 610, and pipe assembly 615. Pipe assembly 615 is representative of an HVAC system installed above room 105 that produces noise that may be audible to person 605 and/or person 610. Noise reduction environment 600 is representative of a common scenario in which noise produced by HVAC systems can disrupt occupants in a residential, commercial, or industrial setting.

By applying the modular surrogate modeling approach and layout optimization techniques disclosed herein, the noise generated by pipe assembly 615 can be reduced to levels that are less intrusive or even imperceptible to persons 605 and 610. For example, these processes can enable the system designer or an optimization module to identify and eliminate resonant frequencies, adjust the placement of pipe segments to minimize noise at key locations, or optimize the overall design for quiet operation. Such improvements not only enhance the comfort and productivity of individuals in workspaces or living environments but also ensure compliance with noise regulations in sensitive areas.

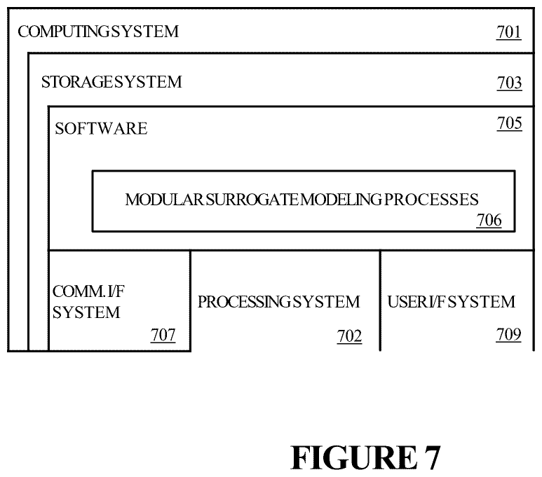

FIG. 7 illustrates computing system 701, which is representative of any system or collection of systems in which the various processes, programs, services, and scenarios disclosed herein may be implemented. Examples of computing system 701 include, but are not limited to, desktop computers, laptop computers, mobile computers, server computers, routers, web servers, cloud computing platforms, and data center equipment, as well as any other type of physical or virtual server machine, container, and any variation or combination thereof.

Computing system 701 may be implemented as a single apparatus, system, or device or may be implemented in a distributed manner as multiple apparatuses, systems, or devices. Computing system 701 includes, but is not limited to, processing system 702, storage system 703, software 705, communication interface system 707, and user interface system 709. Processing system 702 is operatively coupled with storage system 703, communication interface system 707, and user interface system 709. Components of computing system 701 may be optional or excluded in certain implementations.

Processing system 702 loads and executes software 705 from storage system 703. Software 705 includes and implements modular surrogate modeling processes 706, which may be representative of any or all of the decomposition, modeling, summing, and optimization processes discussed with respect to the preceding Figures, such as process 400 and process 500. When executed by processing system 702, software 705 directs processing system 702 to operate as described herein for at least the various processes, operational scenarios, and sequences discussed in the foregoing implementations. Computing system 701 may optionally include additional devices, features, or functionality not discussed for purposes of brevity.

Referring still to FIG. 7, processing system 702 may comprise a microprocessor and other circuitry that retrieves and executes software 705 from storage system 703. Processing system 702 may be implemented within a single processing device but may also be distributed across multiple processing devices or sub-systems that cooperate in executing program instructions. Examples of processing system 702 include general purpose central processing units, graphical processing units, application specific processors, and logic devices, as well as any other type of processing device, combinations, or variations thereof.

Storage system 703 may comprise any computer readable storage media readable by processing system 702 and capable of storing software 705. Storage system 703 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 703 may also include computer readable communication media over which at least some of software 705 may be communicated internally or externally. Storage system 703 may be implemented as a single storage device but may also be implemented across multiple storage devices or sub-systems co-located or distributed relative to each other. Storage system 703 may comprise additional elements, such as a controller, capable of communicating with processing system 702 or possibly other systems.

Software 705 (including modular surrogate modeling processes 706) may be implemented in program instructions and among other functions may, when executed by processing system 702, direct processing system 702 to operate as described with respect to the various operational scenarios, sequences, and processes illustrated herein. For example, software 705 may include program instructions for implementing the pipe assembly decomposition, surrogate modeling, and/or layout optimization processes described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 705 may include additional processes, programs, or components, such as operating system software, virtualization software, or other application software. Software 705 may also comprise firmware or some other form of machine-readable processing instructions executable by processing system 702.

In general, software 705 may, when loaded into processing system 702 and executed, transform a suitable apparatus, system, or device (of which computing system 701 is representative) overall from a general-purpose computing system into a special-purpose computing system customized to perform the various processes described herein. Indeed, encoding software 705 on storage system 703 may transform the physical structure of storage system 703. The specific transformation of the physical structure may depend on various factors in different implementations of this description. Examples of such factors may include, but are not limited to, the technology used to implement the storage media of storage system 703 and whether the computer-storage media are characterized as primary or secondary, etc.

For example, if the computer readable storage media are implemented as semiconductor-based memory, software 705 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 707 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing system 701 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

As will be appreciated by one skilled in the art, aspects of the present disclosure may be embodied as a system, method, or computer program product. Accordingly, aspects of the present disclosure may take the form of an entirely hardware implementation, an entirely software implementation (including firmware, resident software, micro-code, etc.) or an implementation combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms ‘connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above description and associated figures teach the best mode of the disclosure. The following claims specify the scope of the disclosure. Note that some aspects of the best mode may not fall within the scope of the disclosure as specified by the claims. Those skilled in the art will appreciate that the features described above can be combined in various ways to form multiple variations of the disclosure. Thus, the disclosure is not limited to the specific embodiments described above, but only by the following claims and their equivalents. The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having operations, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed or implemented in parallel or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for,” but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

What is claimed is:

1. A computer-implemented method of predicting acoustic output generated by vibration in a pipe assembly of a heating, ventilation, and air conditioning (HVAC) system, the method comprising:
representing the pipe assembly as a plurality of base parts, wherein the base parts include at least straight pipe segments and curved pipe segments;
providing each straight pipe segment of the straight pipe segments as input to a first model, wherein the first model predicts sound generated by straight base parts;
executing the first model to determine an acoustic contribution of each straight pipe segment of the straight pipe segments to the acoustic output;
providing each curved pipe segment of the curved pipe segments as input to a second model, wherein the second model predicts sound generated by curved base parts;
executing the second model to determine an acoustic contribution of each curved pipe segment of the curved pipe segments to the acoustic output; and
summing the acoustic contribution of each straight pipe segment of the straight pipe segments and the acoustic contribution of each curved pipe segment of the curved pipe segments to approximate the acoustic output generated by the vibration in the pipe assembly.

2. The computer-implemented method of claim 1, wherein each of the first model and the second model comprises at least one of a neural network, a boundary element method solver, and a combination of a neural network and a boundary element method.

3. The computer-implemented method of claim 1, wherein:
the first model predicts the acoustic contribution of the straight pipe segments based at least in part on a geometry of the straight pipe segments and one or more vibration characteristics of the straight pipe segments; and
the second model predicts the acoustic contribution of the curved pipe segments based at least in part on a geometry of the curved pipe segments and one or more vibration characteristics of the curved pipe segments.

4. The computer-implemented method of claim 1, further comprising optimizing a layout of the pipe assembly based at least in part on the acoustic output.

5. The computer-implemented method of claim 1, wherein the acoustic output comprises a sound pressure level at a receiver location.

6. The computer-implemented method of claim 1, further comprising:
training the first model using one or more datasets that represent sound generated by straight pipe segments based on their geometry and vibration characteristics; and
training the second model using one or more datasets that represent sound generated by curved pipe segments based on their geometry and vibration characteristics.

7. The computer-implemented method of claim 1, wherein the plurality of base parts further includes at least one additional pipe segment, wherein the at least one additional pipe segment includes at least one of a junction, an elbow, an expansion, a contraction, and a termination.

8. A system for predicting total sound generated by vibration in a pipe assembly, the system comprising:
a decomposition module configured to divide a model of the pipe assembly into a plurality of base parts, wherein the plurality of base parts includes at least straight pipe segments and curved pipe segments;
a modeling module configured to:
execute a first model to determine an acoustic contribution of each straight pipe segment of the straight pipe segments to the total sound, wherein the first model predicts sound generated by the straight pipe segments; and
execute a second model to determine an acoustic contribution of each curved pipe segment of the curved pipe segments to the total sound, wherein the second model predicts sound generated by the curved pipe segments; and
a processor configured to execute the decomposition module and the modeling module to predict the total sound generated by the vibration in the pipe assembly.

9. The system of claim 8, wherein each of the first model and the second model comprises at least one of a neural network, a boundary element method solver, and a combination of a neural network and a boundary element method.

10. The system of claim 8, wherein:
the first model predicts the sound generated by the straight pipe segments based at least in part on a geometry of the straight pipe segments and one or more vibration characteristics of the straight pipe segments; and
the second model predicts the sound generated by the curved pipe segments based at least in part on a geometry of the curved pipe segments and one or more vibration characteristics of the curved pipe segments.

11. The system of claim 8, further comprising an optimization module configured to optimize a layout of the pipe assembly based at least in part on the total sound.

12. The system of claim 8, wherein the total sound comprises a sound pressure level at a receiver location.

13. The system of claim 8, further comprising a training module configured to:
train the first model using datasets that represent sound generated by straight pipe segments based on their geometry and vibration characteristics; and
train the second model using datasets that represent sound generated by curved pipe segments based on their geometry and vibration characteristics.

14. The system of claim 8, wherein the plurality of base parts further includes at least one additional pipe segment, wherein the at least one additional pipe segment includes at least one of a junction, an elbow, an expansion, a contraction, and a termination.

15. One or more non-transitory computer-readable storage media having program instructions stored thereon for predicting acoustic output generated by vibration in a pipe assembly, wherein the program instructions, when executed by a computing system, direct the computing system to perform operations, the operations comprising:
representing the pipe assembly as a plurality of base parts, wherein the base parts include at least straight pipe segments and curved pipe segments;
executing a first model to determine an acoustic contribution of each straight pipe segment of the straight pipe segments to the acoustic output;
executing a second model to determine an acoustic contribution of each curved pipe segment of the curved pipe segments to the acoustic output; and
summing the acoustic contribution of each straight pipe segment of the straight pipe segments and the acoustic contribution of each curved pipe segment of the curved pipe segments to approximate the acoustic output generated by the vibration in the pipe assembly.

16. The one or more non-transitory computer-readable storage media of claim 15, wherein each of the first model and the second model comprises at least one of: a neural network, a boundary element method solver, and a combination of a neural network and a boundary element method.

17. The one or more non-transitory computer-readable storage media of claim 15, wherein:
the first model predicts the acoustic contribution of the straight pipe segments based at least in part on a geometry of the straight pipe segments and one or more vibration characteristics of the straight pipe segments; and
the second model predicts the acoustic contribution of the curved pipe segments based at least in part on a geometry of the curved pipe segments and one or more vibration characteristics of the curved pipe segments.

18. The one or more non-transitory computer-readable storage media of claim 15, the operations further comprising optimizing a layout of the pipe assembly based at least in part on the acoustic output.

19. The one or more non-transitory computer-readable storage media of claim 15, wherein the acoustic output comprises a sound pressure level at a receiver location.

20. The one or more non-transitory computer-readable storage media of claim 15, the operations further comprising:
training the first model using one or more datasets that represent sound generated by straight pipe segments based on their geometry and vibration characteristics; and
training the second model using one or more datasets that represent sound generated by curved pipe segments based on their geometry and vibration characteristics.
